(19) United States
(12) Patent Application Publication
(10) Pub. No.: US 2013/0167132 A1
(43) Pub. Date: Jun. 27, 2013

(54) SYSTEM, ELECTRONIC DEVICE WITH FIRMWARE UPDATING FUNCTION AND METHOD THEREFOR

(71) Applicants: MING-SHIU OU YANG, Tu-Cheng (TW); CHUNG-JEN HSIEH, Tu-Cheng (TW); WEI-YUAN CHEN, Tu-Cheng (TW)

(72) Inventors: MING-SHIU OU YANG, Tu-Cheng (TW); CHUNG-JEN HSIEH, Tu-Cheng (TW); WEI-YUAN CHEN, Tu-Cheng (TW)

(73) Assignee: HON HAI PRECISION INDUSTRY CO., LTD., Tu-Cheng (TW)

(21) Appl. No.: 13/480,479

(22) Filed: May 25, 2012

(30) Foreign Application Priority Data
Dec. 22, 2011 (TW) 100148142

(51) Int. Cl. G06F 9/44

(52) U.S. Cl. 717/171

(57) ABSTRACT

A system with a firmware updating method is applied between a primary electronic device and at least one secondary electronic device. When the primary electronic device detects that one firmware of the at least one secondary electronic device runs error and needs to be updated, the primary electronic device acquires a corresponding firmware according to an alert from the at least one secondary electronic device and transforms the corresponding firmware to the at least one secondary electronic device; or the at least one secondary electronic device detects running situation itself and acquires the corresponding firmware from the primary electronic device, thereby updating the firmware of the at least one secondary electronic device.

### BACKGROUND

1. Technical Field

The disclosure relates to electronic devices and, more particularly, to a system and an electronic device with firmware updating function and a firmware updating method adapted for the system.

2. Description of Related Art

When an electronic device needs a firmware update, a specific interface, such as a joint test action group interface, is often needed for updating the firmware. However, most of electronic devices do not have a specific interface for such purpose, therefore, when a user wants to update the firmware, the user have to remove a chip burned with the old firmware and burn an updated firmware to the chip, which is inconvenient and time-consuming.

Therefore, what is needed is an electronic device to overcome the described shortcoming.

### BRIEF DESCRIPTION OF THE DRAWINGS

FIG. 1 is a schematic diagram of a system with firmware updating function in accordance with an exemplary embodiment.

FIG. 2 is a block diagram of a primary electronic device of the system of FIG. 1.

FIG. 3 is a flowchart of updating firmware method adapted for the system of FIG. 1.

### DETAILED DESCRIPTION

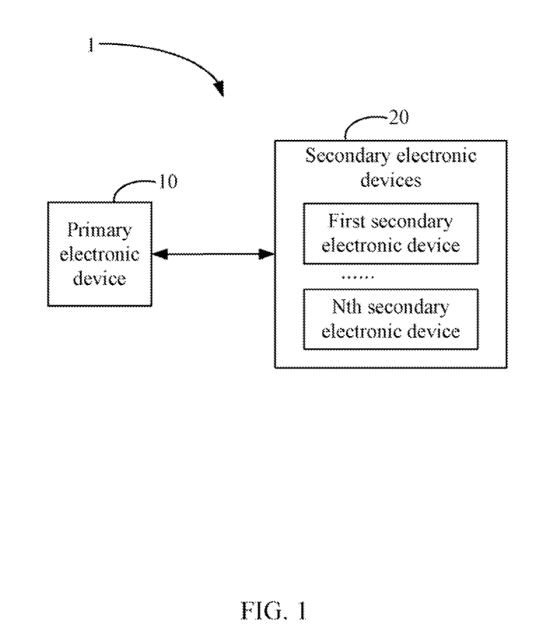

FIG. 1 is a schematic diagram of a system with firmware updating function in accordance with an exemplary embodiment. The system with firmware updated function (hereinafter “system”) 1 is applied between a primary electronic device 10 and at least one secondary electronic device 20. The primary electronic device 10 communicates with the at least one secondary electronic device 20 by wire or wireless. Each of the at least one secondary electronic device 20 may be a computer and stores firmware for supporting the running of an operating system of the computer.

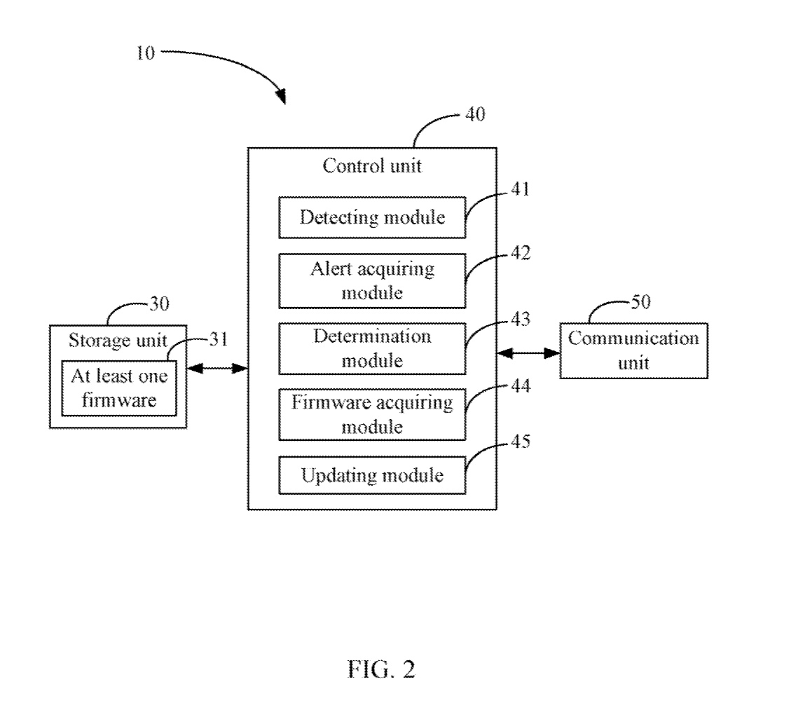

FIG. 2 is a block diagram of a primary electronic device of the system of FIG. 1. The primary electronic device 10 includes a storage unit 30, a control unit 40, and a communication unit 50. The storage unit 30 stores at least one firmware 31. In the embodiment, the storage unit 30 is a nonvolatile random access memory. For example, the firmware 31 of a screen includes on-screen display for controlling the screen. The communication unit 50 communicates with the at least one secondary electronic device 20 through a USB port or a Bluetooth module.

The control unit 40, e.g., a processor, includes a detecting module 41, an alert acquiring module 42, a determination module 43, a firmware acquiring module 44, and an updating module 45. The primary electronic device 10 establishes a communication link with each of the at least one secondary electronic device 20 via the communication unit 50.

The detecting module 41 monitors each of the at least one secondary electronic device 20 running in real time. The determination module 43 determines whether the detecting module 41 detects an abnormal operation condition of one of the at least one secondary electronic device 20. In other words, the determination module 41 determines whether to receive an alert from one of the at least one secondary electronic device 20 for an abnormality via the communication unit 50. When the detecting module 41 detects an abnormal operation condition of one of the at least one secondary electronic device 20, the alert acquiring module 42 acquires the alert generated from the one of the at least one secondary electronic device 20 via the communication unit 50.

The determination module 43 determines whether the alert contains reference to a firmware of the one of the at least one secondary electronic device 20. In the embodiment, the reference to each firmware includes at least one keyword which reflects the firmware of the one of the at least one secondary electronic device 20. For example, the reference to the screen firmware includes keywords “brightness,” “temperature,” etc. If the alert does not contain reference to any firmware, the running of the one of the at least one secondary electronic device 20 has a problem from other hardware. If the alert contains reference to one firmware of the one of the at least one secondary electronic device 20, that means that the firmware 31 of the one of the at least one secondary electronic device 20 has a problem and needs to be updated. The firmware acquiring module 44 acquires a firmware 31 from the at least one firmware of the storage unit 30 based on the reference. The updating module 45 generates an updating command to update the firmware 31 of the one of the at least one secondary electronic device 20 with the acquired firmware 31, so as to normalize the running of the at least one secondary electronic device 20.

In another embodiment, each of the at least one secondary electronic device 20 includes the control unit 40 which includes the detecting module 41, the alert acquiring module 42, the determination module 43, the firmware acquiring module 44, and the updating module 45. The detecting module 41 monitors the running of one of the at least one secondary electronic device 20 in real time. The determination module 43 determines whether the detecting module 43 detects an abnormal operation condition of the one of the at least one secondary electronic device 20. When the detecting module 43 detects an abnormal operation condition of the one of the at least one secondary electronic device 20, the alert acquiring module 42 acquires an alert.

The determination module 43 determines whether the alert contains reference to of a firmware of the one of the at least one secondary electronic device 20. If the alert does not contain reference to any firmware, the determination module 43 determines that the running of the one of the at least one secondary electronic device 20 has a problem from other hardware. If the alert contains reference to one firmware, the firmware acquiring module 44 acquires a firmware 31 from the at least one firmware 31 of the storage unit 30 based on the reference via the communication unit 50. The updating module 45 generates an updating command to update the firmware 31 of the one of the at least one secondary electronic device 20 with the acquired firmware 31.

In other embodiments, the primary electronic device 10 includes some of the detecting module 41, the alert acquiring module 42, the determination module 43, the firmware acquiring module 44, and the updating module 45, and each of the at least one secondary electronic device 20 includes the other modules.

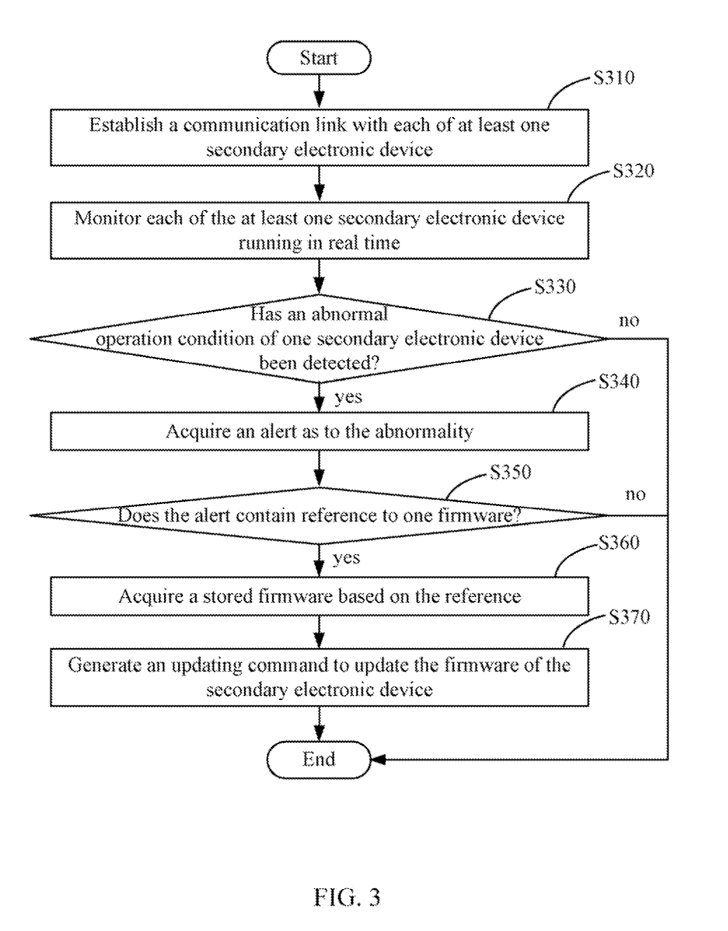

FIG. 3 is a flowchart of updating firmware method adapted for the system of FIG. 1.

In step S310, the primary electronic device 10 establishes a communication link with each of the at least one secondary electronic device 20 via the communication unit 50. In step S320, the detecting module 41 monitors each of the at least one secondary electronic device 20 running in real time. In step S330, the determination module 43 determines whether the detecting module 41 detects an abnormal operation condition of one of the at least one secondary electronic device 20.

In step S340, if the detecting module 41 detects an abnormal operation condition of one of the at least one secondary electronic device 20, the alert acquiring module 42 acquires the alert generated from the one of the at least one secondary electronic device 20 via the communication unit 50. If the detecting module 41 does not detect an abnormal operation condition of one of the at least one secondary electronic device 20, the procedure ends.

In step S350, the determination module 43 determines whether the alert contains reference to a firmware of the one of the at least one secondary electronic device 20. If the alert does not contain reference to any firmware, the procedure ends. In step S360, if the alert contains reference to one firmware, the firmware acquiring module 44 acquires a firmware from the at least one firmware of the storage unit 30 based on the reference. In step S360, the updating module 45 generates an updating command to update the firmware of the one of the at least one secondary electronic device 20 based on the acquired firmware.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A system with firmware updating function, wherein the system is applied between a primary electronic device and at least one secondary electronic device, the primary electronic device communicates with the at least one secondary electronic device, and the primary electronic device stores at least one firmware, the system comprising:
a control unit, comprising:
a detecting module to monitor each of the at least one secondary electronic device running in real time;
an alert acquiring module to acquire an alert generated from one of the at least one secondary electronic device when the detecting module detects an abnormal operation condition of the one of the at least one secondary electronic device;
a determination module to determine whether the alert contains reference to a firmware of the one of the at least one secondary electronic device;
a firmware acquiring module to acquire a firmware from the at least one firmware based on the reference when the alert contains reference to the firmware; and
an updating module to generate an updating command to update the firmware of the one of the at least one secondary electronic device with the acquired firmware.

2. The system of claim 1, wherein the primary electronic device comprises a nonvolatile random access memory for storing the at least one firmware.

3. The system of claim 1, wherein the reference comprises at least one keyword which reflects the firmware of the one of the at least one secondary electronic device.

4. An electronic device for updating firmware of at least one secondary electronic device, the electronic device comprising:
a storage unit to store at least one firmware;
a communication unit to communicate with the at least one secondary electronic device;
a control unit comprising:
a detecting module to monitor each of the at least one secondary electronic device running in real time;
an alert acquiring module to acquire an alert generated from one of the at least one secondary electronic device when the detecting module detects an abnormal operation condition of the one of the at least one secondary electronic device;
a determination module to determine whether the alert contains reference to a firmware of the one of the at least one secondary electronic device;
a firmware acquiring module to acquire a firmware from the at least one firmware in the storage unit based on the reference when the alert contains the reference to the firmware of the one of the at least one secondary electronic device; and
an updating module to generate an updating command to update the firmware of the one of the at least one secondary electronic device with the acquired firmware.

5. The electronic device of claim 4, wherein the storage unit is a nonvolatile random access memory.

6. The electronic device of claim 4, wherein the reference comprises at least one keyword which reflects the firmware of the one of the at least one secondary electronic device.

7. A firmware updating method of a system, wherein the system is applied between a primary electronic device and at least one secondary electronic device, the primary electronic device communicates with the at least one secondary electronic device, and the primary electronic device stores at least one firmware, the method comprising:
monitoring each of the at least one secondary electronic device running in real time;
acquiring an alert generated from one of the at least one secondary electronic device when an abnormal operation condition of the one of the at least one secondary electronic device has been detected;
determining whether the alert contains reference to a firmware of the one of the at least one secondary electronic device;
if the alert contains reference to a firmware, acquiring a firmware from the at least one firmware based on the reference; and
generating an updating command to update the firmware of the one of the at least one secondary electronic device with the acquired firmware.
